(19) United States
(12) Patent Application Publication
(10) Pub. No.: US 2010/0325684 A1
(43) Pub. Date: Dec. 23, 2010

(54) ROLE-BASED SECURITY FOR MESSAGING ADMINISTRATION AND MANAGEMENT

(75) Inventors: Vladimir V. Grebenik, Redmond, WA (US); Pretish Abraham, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/485,945

(22) Filed: Jun. 17, 2009

(51) Int. Cl. G06F 21/00; G06F 17/30

(52) U.S. Cl. 726/1; 709/206; 707/783; 707/770

(57) ABSTRACT

A role-based access control (RBAC) for the administration of complex services, such as for messaging. The RBAC architecture facilitates the creation of a role mechanism that describes any end-user, administrator, or partner action, of a set of scopes that address all populations, and a single authorization mechanism to handle role assignments through various mechanisms. Moreover, role and scope concepts are provided that universally apply to various management scenarios. A common set of primitives is defined that represent actions of enterprise and tenant end-users, partners, tenant administrators, datacenter administrators, and enterprise administrators. The primitives can include actions, action parameters, and API calls. Additionally, a set of scopes is defined that include self-relative scopes for end-users and tenants, and, absolute and filter-based scopes for administrators.

### BACKGROUND

The management of complex enterprise services associated can be difficult. For example, there are multiple users/administrators that need to have different levels of access. Assigning these permissions with sufficient granularity over a multitude of heterogeneous resources (e.g., files, email items, objects in directory, etc.) is a challenging task because the assignment depends on the what user needs to perform the associated business function, as well as implementation details of what these business functions need to touch in order to perform desired action.

With respect to enterprise messaging, these implementation details can change frequently over time. For example, creating a new mailbox requires permissions to create a new user account, modify several properties, and access to a particular mailbox database.

There are several management and authorization scenarios that demand to be addressed for complex message systems, to include system administration, service administration, tenant administration, and self-service administration. System administration involves deploying and maintaining servers, system configuration tasks, provisioning and maintenance of recipients, etc. Management service administration involves management actions to run multi-tenant hosted services such as the creation and maintenance of hosted organizations, and interactions with partner services and service upgrades. Tenant administration involves management actions that hosted organization administrators can perform, such as changing settings of the hosted organization, adding or removing recipients, etc. Self-service administration involves management actions that can be delegated to a user, such as changing a name or address and, creation and maintenance of distribution lists and email subscriptions.

Disparate approaches to addressing these complex services in a corporate environment create inconsistencies, duplication of resources, and the unintended exposure of secure information, just to name a few.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides a unified approach to the administration of complex services, such as for messaging. The architecture employs role-based access control (RBAC) to facilitate the creation of a role mechanism that describes any end-user, administrator, or partner action, of a set of scopes that address all populations, and a single authorization mechanism to handle role assignments through various mechanisms. Moreover, role and scope concepts are provided that universally apply to various management scenarios.

Specifically, a common set of primitives is defined that represent actions of end-users, partners, tenants, datacenter administrators and enterprise administrators. The primitives can include actions, action parameters, and API calls. Additionally, a set of scopes is defined that includes self-relative scopes for end-users and tenants, and, absolute and filter-based scopes for administrators.

A single role assignment mechanism applies to all categories of users and administrators. Roles can be assigned using several mechanisms, such as direct assignment to a user, assignment to a security group, and assignment to a policy (and then assigned to numerous end-users). These assignments can be created, retrieved and managed using the same tool set. Messaging system components do not need to be aware of details, as all authorization cases are handled by a common RBAC layer.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates computer-implemented administration system in accordance with the disclosed architecture.

FIG. 2 illustrates an alternative embodiment administration system.

FIG. 3 illustrates a system for role and scope assignment to a user.

FIG. 4 illustrates example roles for general administration and tenant administration.

FIG. 5 illustrates a computer-implemented method of service administration.

FIG. 6 illustrates further aspects of the method of FIG. 5.

FIG. 7 illustrates further aspects of the method of FIG. 5.

FIG. 8 illustrates a block diagram of a computing system operable to execute RBAC as applied to a messaging infrastructure in accordance with the disclosed architecture.

FIG. 9 illustrates a schematic block diagram of a computing environment that supports role-base security for a messaging infrastructure.

### DETAILED DESCRIPTION

The disclosed architecture is a role-based access control (RBAC) layer that imposes role and scope concepts universally to management scenarios as applied to a messaging infrastructure. The RBAC facilitates the definition of meanings and capabilities of scopes and roles, the definition of a schema and storage for scopes and roles, actions (also referred to as cmdlets or “commandlets”) for scope and role management, ensures that administrators can only run operations within an assigned role (e.g., only using allowed actions parameters for each action), and ensuring that administrators can only view or modify objects within the assign scope. The RBAC also facilitates secure implementation of the above, determination of role and scope of a user, and multi-tenancy in actions (cmdlets) by providing the appropriate default scopes.

The RBAC architecture as applied to messaging creates a role mechanism that describes any end-user, administrator, and/or partner action, creates a set of scopes that address all populations, and creates a single authorization mechanism to handle role assignments through various mechanisms.

The architecture defines a common set of primitives that represent actions of end-users, partners, tenants, datacenter administrators and enterprise administrators. The primitives can be represented by cmdlets and API calls. Additionally, a set of scopes is defined that include self-relative scopes for end-users and tenants, and, absolute and filter-based scopes for administrators.

A single role assignment mechanism applies to all categories of users and administrators. Roles can be assigned using several ways, such as direct assignment to a user, assignment to a security group, and assignment to a policy (and then assigned to numerous end-users). These assignments can be created, retrieved and managed using the same tool set. Messaging system components do not need to be aware of details, as all authorization cases are handled by a common RBAC layer.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

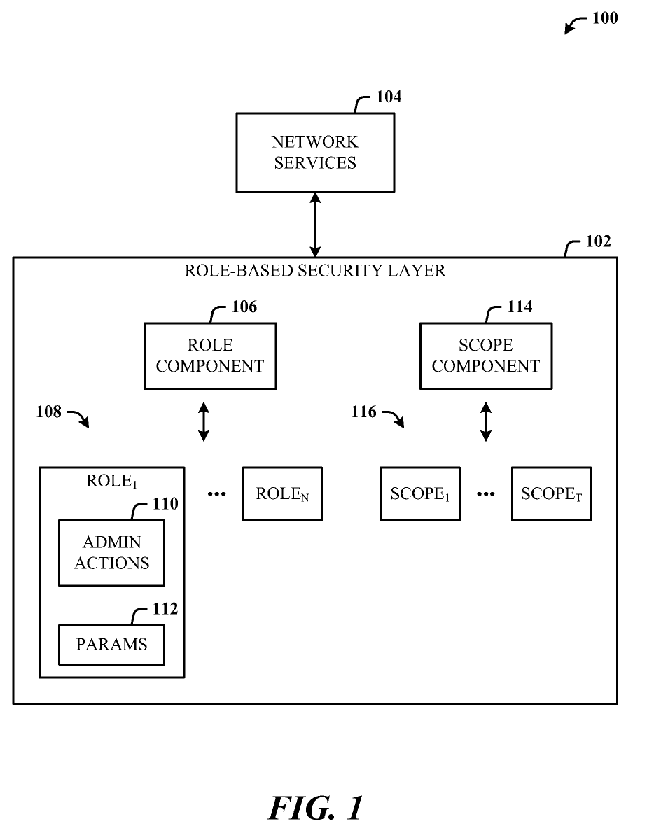

FIG. 1 illustrates computer-implemented administration system 100 in accordance with the disclosed architecture. The system 100 includes a role-based security layer 102 for providing the administration of network services 104. The security layer 102 can include a role component 106 for defining roles 108 that represent administrative (admin) actions 110 and action parameters (params) 112, and a scope component 114 for defining scopes 116 for the roles 108. The scopes 116 define objects on which the administrative actions 110 and action parameters 112 operate.

The role-based security layer 102 is applied to a network infrastructure for the administration of the network services 104, which can be messaging services. The roles 108 and scopes 116 can provide management actions for multi-tenant hosted service administration. The roles 108 and scopes 116 can provide management actions for tenant administration. The roles 108 and scopes 116 can provide management actions for self-service administration. The roles 108 can be assigned directly to users. The roles 108 can be assigned to security groups. The roles 108 can be assigned to end-users via an initial assignment to policies.

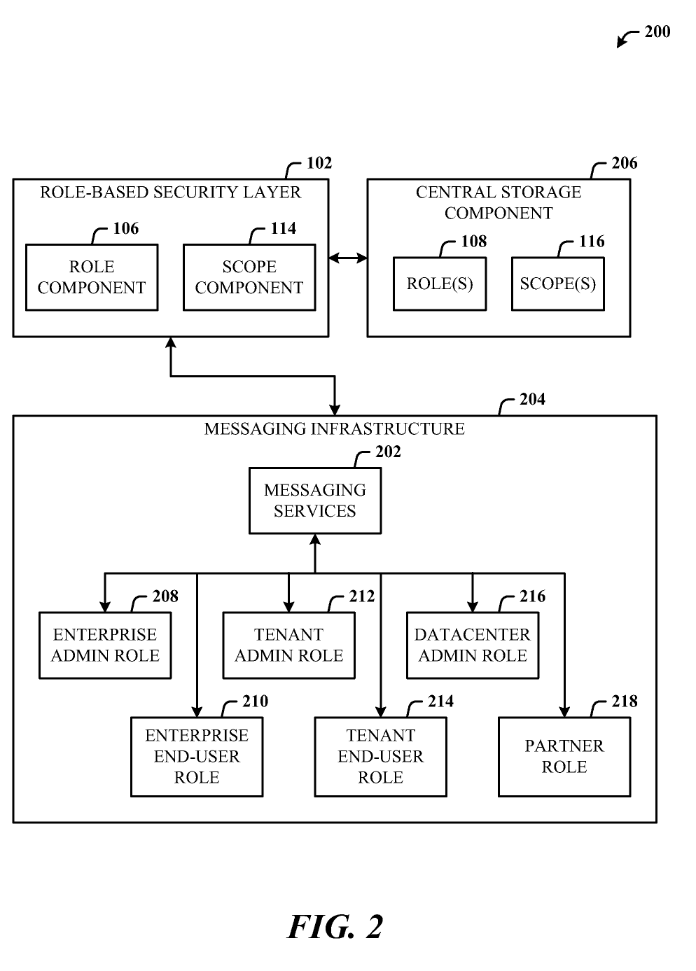

FIG. 2 illustrates an alternative embodiment administration system 200. The system 200 includes the role-based security layer 102 for providing the administration of messaging services 202 of a messaging infrastructure 204. The security layer 102 includes the role component 106 for defining roles 108 that represent administrative (admin) actions and action parameters, and the scope component 114 for defining scopes 116 for the roles 108. The scopes 116 define objects on which the administrative actions and action parameters operate. The system 200 also includes a centrally located storage component 206 for storing the roles 108 and scopes 116 and from which to administer the messaging services 202.

The roles 108 and scopes 116 provide management actions for tenant and multi-tenant hosted service administration. The roles 108 and scopes 116 provide management actions for delegation to a user. The roles 108 are assigned at least one of directly to users, to security groups, or to end-users via an initial assignment to policies. The role-based security layer 102 provides the ability to create and apply the roles 108, which can include an enterprise administrator (admin) role 208, enterprise end-user role 210, tenant administrator role 212, tenant end-user role 214, a datacenter administrator role 216, and a partner role 218, for example.

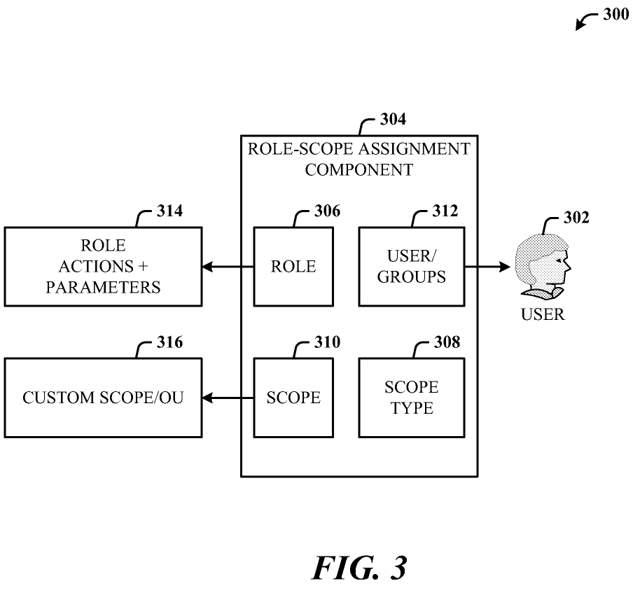

FIG. 3 illustrates a system 300 for role and scope assignment to a user 302. The system 300 includes a role-scope assignment component 304 (e.g., role-based security layer 102 of FIG. 1) for defining a role 306, scope type 308, scope 310 for the scope type 308, and then assigning the role 306 and scope 310 to a user (e.g., user 302) or groups of users 312. The role 306 includes role actions (also referred to as commandlets—“cmdlets”) and action parameters 314 that define the permissions associated with the role 306. The system 300 also includes derivations of the scope 310, which comprise custom scope or an organizational unit (OU) scope 316.

Roles and scopes can be assigned to both users and groups. Ways in which to grant administrators roles and scopes include indirectly by adding the administrator to a group that is already granted a specific scope and role, and directly using scope and role assignment cmdlets.

Using groups for delegation is a natural way of simplifying things, but in the RBAC there is a danger that a recipient administrator or someone who has permissions to add a distribution group member in the same scope as that group will be able to add itself to any administration group. To mitigate this problem the groups used for delegation can live in a separate scope (e.g., a custom scope or a top-level OU).

Self-service roles and scopes find particular application for hosted deployments to reduce the administrator/user ratio. A self-service autogroup (distribution group management) functionality provides this capability. The self-service scenarios can include supporting end-user and self-group management. For example, an end-user is provided access to manage personal data. This can be provided as an out-of-the-box self role for which the user has self write permission and self read permission. The self role can also have access to set-mailbox and set-user cmdlet, for example.

The user can also create a DL (distribution list) and is restricted to modify only DLs the user can own. A self DL management role is created and has a write restriction filter to set only DLs that users own—which (managedBy=user) filter.

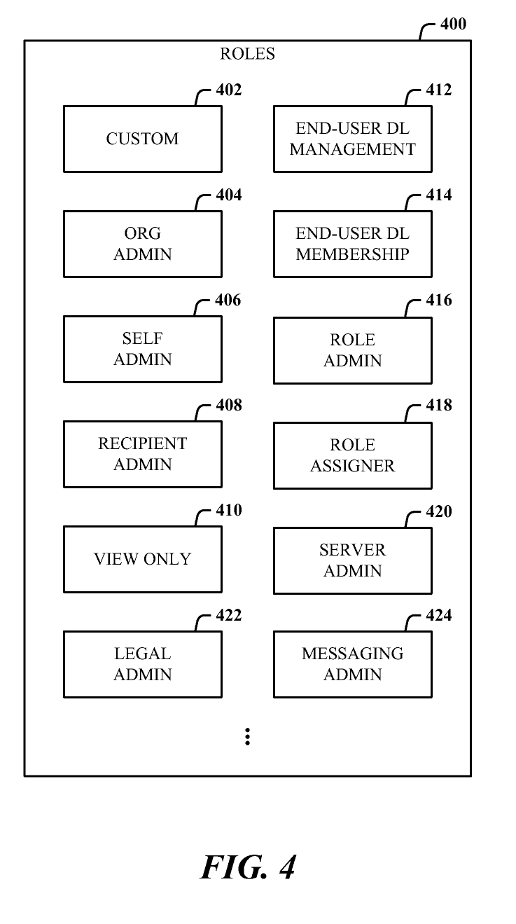

FIG. 4 illustrates example roles 400 for general administration and tenant administration. A custom role 402 is a role built to contain scripts for execution by role assignees. An org admin role 404 can be for tenants, has access to all cmdlets, with read and write permissions for the organization container and configuration container. A self admin role 406 is a role for an end-user, has limited cmdlet access, and is intended for the end-user to set the display name and title. Read and write scope is limited to self, and there is no configuration access. A recipient admin role 408 can be employed to tenant recipient administration and includes recipient cmdlets with read and write permissions for the relative organization container and configuration container.

A view only role 410 includes all Get-* cmdlets. No write-based cmdlets are included. An end-user DL management role 412 is for self-DL management. The end-user is able to create and manage self-generated DLs. There is no configuration container access. An end-user DL membership role 414 is for users to join or depart any DL. A role admin role 416 provides access to all RBAC cmdlets, and is typically assigned to organization administrators. A role assigner role 418 provides access to add/get/remove role assignments without delegating or exclusive parameters. A server admin role 420 provides general server administration that can enable delegated setup and other server management functionality. A legal admin role 422 can be provided for legal compliance administration. This role can have read access to the configuration container and write access to messaging servers. A messaging admin role 424 is provided for managing messaging recipient and configuration information. This role has write access to domain users only, and read access to configuration. Other roles can be provided as desired.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

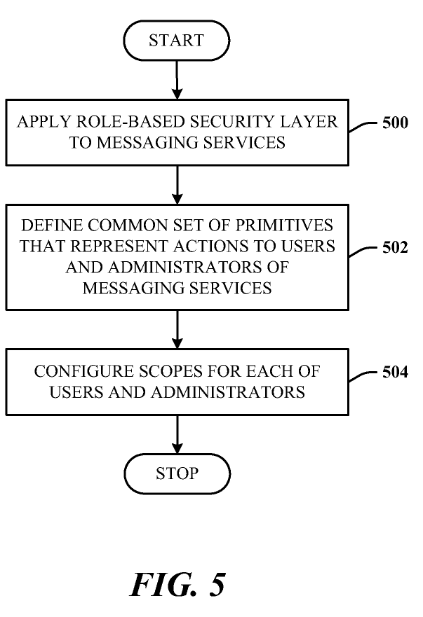

FIG. 5 illustrates a computer-implemented method of service administration. At 500, a role-based security layer is applied to messaging services. At 502, a common set of primitives that represent actions to users and administrators of the messaging services is defined. At 504, scopes are configured for each of the users and administrators.

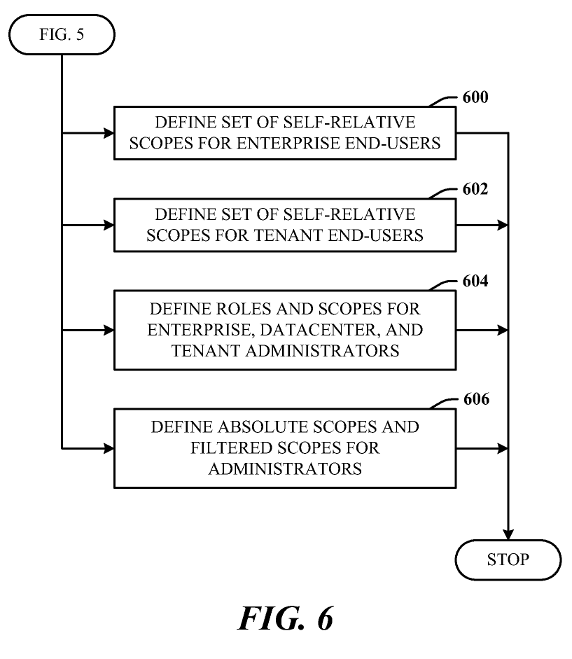

FIG. 6 illustrates further aspects of the method of FIG. 5. At 600, a set of self-relative scopes for enterprise end-users is defined. At 602, a set of self-relative scopes is defined for tenant end-users. At 604, roles and scopes are defined for enterprise, datacenter, and tenant administrators. At 608, absolute scopes and filtered scopes are defined for administrators (e.g., enterprise, datacenter, tenant).

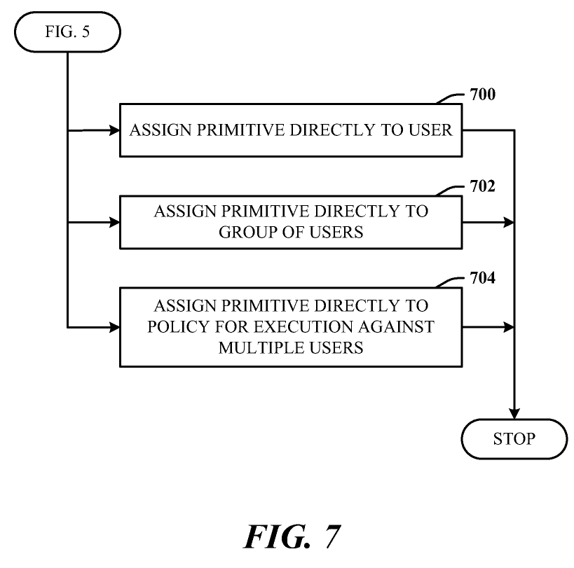

FIG. 7 illustrates further aspects of the method of FIG. 5. At 700, a primitive is assigned directly to a user. At 702, a primitive is assigned directly to a group of users. At 704, a primitive is assigned directly to a policy for execution against multiple users.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

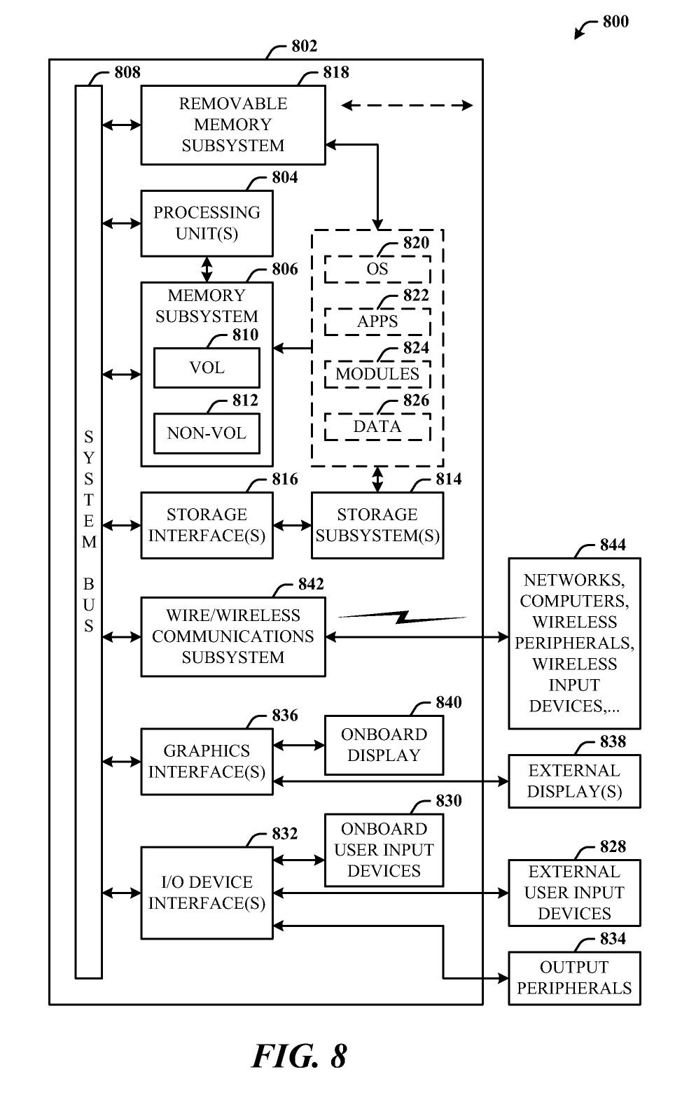

Referring now to FIG. 8, there is illustrated a block diagram of a computing system 800 operable to execute RBAC as applied to a messaging infrastructure in accordance with the disclosed architecture. In order to provide additional context for various aspects thereof, FIG. 8 and the following discussion are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804, a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the memory subsystem 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes storage subsystem(s) 814 and storage interface(s) 816 for interfacing the storage subsystem(s) 814 to the system bus 808 and other desired computer components. The storage subsystem(s) 814 can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The one or more application programs 822, other program modules 824, and program data 826 can include the components and entities described in accordance with system 100 of FIG. 1, the components and entities described in accordance with system 200 of FIG. 2, the components and entities described in accordance with system 300 of FIG. 3, the roles 400 of FIG. 4, and the methods and method steps represented by the flow charts of FIGS. 5-7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Computer readable media can be any available media that can be accessed by the computer 802 and includes volatile and non-volatile media, removable and non-removable media. For the computer 802, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP) using logical connections via a wired/wireless communications subsystem 842 to one or more networks and/or other computers. The other computers can include workstations, servers, routers, personal computers, microprocessor-based entertainment appliance, a peer device or other common network node, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or has other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

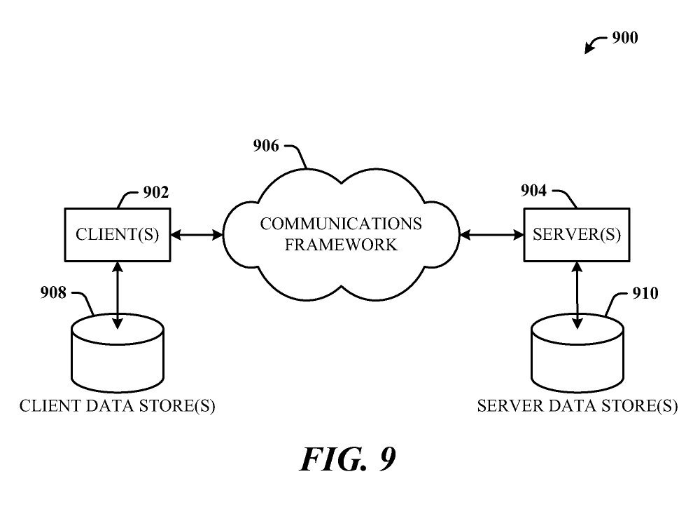

Referring now to FIG. 9, there is illustrated a schematic block diagram of a computing environment 900 that supports role-base security for a messaging infrastructure. The environment 900 includes one or more client(s) 902. The client(s) 902 can be hardware and/or software (e.g., threads, processes, computing devices). The client(s) 902 can house cookie(s) and/or associated contextual information, for example.

The environment 900 also includes one or more server(s) 904. The server(s) 904 can also be hardware and/or software (e.g., threads, processes, computing devices). The servers 904 can house threads to perform transformations by employing the architecture, for example. One possible communication between a client 902 and a server 904 can be in the form of a data packet adapted to be transmitted between two or more computer processes. The data packet may include a cookie and/or associated contextual information, for example. The environment 900 includes a communication framework 906 (e.g., a global communication network such as the Internet) that can be employed to facilitate communications between the client(s) 902 and the server(s) 904.

Communications can be facilitated via a wire (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented administration system, comprising:
a role-based security layer for providing administration of network services;
a role component of the security layer for defining roles that represent administrative actions; and
a scope component of the security layer for defining scopes for the roles, the scopes define objects on which the administrative actions operate.

2. The system of claim 1, wherein the role-based security layer is applied to a messaging infrastructure for the administration of the network services, which are messaging services, for at least one of an enterprise or a tenant.

3. The system of claim 1, wherein the roles and scopes provide management actions for multi-tenant hosted service administration.

4. The system of claim 1, wherein the roles and scopes provide management actions for tenant administration.

5. The system of claim 1, wherein the roles and scopes provide management actions for self-service administration of tenant end-users.

6. The system of claim 1, wherein the roles and scopes provide management actions for self-service administration enterprise end-users.

7. The system of claim 1, wherein the roles are assigned to security groups and directly to users.

8. The system of claim 1, wherein the roles are assigned to end-users via an initial assignment to policies.

9. A computer-implemented administration system, comprising:
a role-based security tool for administration of messaging services, the tool comprising,
a role component of the security layer for defining roles for users and administrators that represent administrative actions; and
a scope component of the security layer for defining scopes for the roles, the scopes define objects on which the administrative actions operate; and
a centrally located storage component for storing the roles and scopes and from which to administer the messaging services.

10. The system of claim 9, wherein the roles and scopes provide management actions for tenant service administration, multi-tenant hosted service administration, enterprise administration, partner service administration, and datacenter service administration.

11. The system of claim 9, wherein the roles and scopes provide management actions for delegation to a user.

12. The system of claim 9, wherein the roles are assigned at least one of directly to users, to security groups, or to end-users via an initial assignment to policies.

13. A computer-implemented method of service administration, comprising:
applying a role-based security layer to messaging services;
defining a common set of primitives that represent actions to users and administrators of the messaging services; and
configuring scopes for each of the users and administrators.

14. The method of claim 13, further comprising defining a set of self-relative scopes for enterprise end-users.

15. The method of claim 13, further comprising defining a set of self-relative scopes for tenant end-users.

16. The method of claim 13, further comprising defining roles and scopes for enterprise, datacenter, and tenant administrators.

17. The method of claim 13, further comprising defining absolute scopes and filtered scopes for administrators.

18. The method of claim 13, further comprising assigning a primitive directly to a user.

19. The method of claim 13, further comprising assigning a primitive directly to a group of users.

20. The method of claim 13, further comprising assigning a primitive directly to a policy for execution against multiple users.
